(19) United States
(12) Patent Application Publication
(10) Pub. No.: US 2018/0086604 A1
(43) Pub. Date: Mar. 29, 2018

(54) ELEVATOR CAR WALL FOR ACCESS TO HOISTWAY

(71) Applicants: Nicolas FONTENEAU, Gien (FR); Otis Elevator Company, Farmington, CT (US)

(72) Inventors: Nicolas Fonteneau, Vitry aux Loges (FR); Frédéric Beauchaud, Coullons (FR); Emmanuel Convard, Gien (FR)

(21) Appl. No.: 15/565,290

(22) PCT Filed: Apr. 9, 2015
(86) PCT No.: PCT/IB2015/000621

§ 371 Date: Oct. 9, 2017

(51) Int. Cl. B66B 11/02; B66B 9/00; B66B 5/00

(52) U.S. Cl. CPC B66B 11/0246; B66B 5/0087; B66B 9/00

(57) ABSTRACT

An elevator car for an elevator system includes a floor and one or more elevator car side walls. At least one elevator car side wall is configured to be linearly translatable at least partially across the floor from an operational position to a maintenance position to allow for inspection and/or maintenance of elevator system components from inside of the elevator car when the elevator car side wall is at the maintenance position. A method of operating an elevator system includes driving an elevator car along a hoistway, stopping the elevator car at a first selected location along the hoistway and linearly translating a side wall of the elevator car at least partially across a floor of the elevator car from an operational position to a maintenance position, defining a maintenance area between the side wall and the hoistway. Maintenance operations on elevator system components are performed from the maintenance area.

### BACKGROUND

The subject matter disclosed herein relates to elevator systems. More particularly, the present disclosure relates to maintenance of elevator system components.

A typical elevator system includes an elevator car that moves along a hoistway. The elevator system also includes various systems, such as drive systems, electrical systems, governor and tensioning device, a machine that drives the elevator car along the hoistway, and lighting systems that are typically located in the hoistway.

The systems and components in the hoistway require periodic inspection, maintenance and/or repair. Such maintenance is typically performed by a technician entering the hoistway. Regulatory bodies have specified increases in safety volume and clearance for technicians entering the hoistway resulting in a larger overall volume of the elevator systems, while elevator system customers desire that the elevator system occupy a smaller overall volume, thus it is desired to perform maintenance and/or repair operations from other locations, such as from inside the elevator car, whenever possible. To do so, a way for a technician to access the hoistway from inside the elevator car must be provided.

### BRIEF SUMMARY

In one embodiment, an elevator car for an elevator system includes a floor and one or more elevator car side walls. At least one elevator car side wall is configured to be linearly translatable at least partially across the floor from an operational position to a maintenance position to allow for inspection and/or maintenance of elevator system components from inside of the elevator car when the elevator car side wall is at the maintenance position.

Additionally or alternatively, in this or other embodiments a scissor arm arrangement operably connects the movable elevator car side wall to a stationary elevator car structure, to guide the linear translation of the elevator car side wall across the floor.

Additionally or alternatively, in this or other embodiments a roller is affixed to the elevator car side wall and interactive with the floor to support the elevator car side wall during translation across the floor.

Additionally or alternatively, in this or other embodiments a biasing member is utilized to bias the elevator car side wall toward the maintenance position.

Additionally or alternatively, in this or other embodiments a lock is utilized to retain the elevator car side wall at the operational position.

In another embodiment, an elevator system includes a hoistway, one or more elevator system components located in the hoistway and an elevator car drivable along the hoistway. The elevator car includes a floor and one or more elevator car side walls. At least one elevator car side wall is configured to be linearly translatable at least partially across the floor from an operational position to a maintenance position to allow for inspection and/or maintenance of the elevator system components located in the hoistway from inside of the elevator car when the elevator car side wall is at the maintenance position.

Additionally or alternatively, in this or other embodiments a scissor arm arrangement operably connects the movable elevator car side wall to a stationary elevator car structure, to guide the linear translation of the elevator car side wall across the floor.

Additionally or alternatively, in this or other embodiments a roller is affixed to the elevator car side wall and interactive with the floor to support the elevator car side wall during translation across the floor.

Additionally or alternatively, in this or other embodiments a biasing member is utilized to bias the elevator car side wall toward the maintenance position.

Additionally or alternatively, in this or other embodiments a lock is utilized to retain the elevator car side wall at the operational position.

In yet another embodiment, a method of operating an elevator system includes driving an elevator car along a hoistway, stopping the elevator car at a first selected location along the hoistway and linearly translating a side wall of the elevator car at least partially across a floor of the elevator car from an operational position to a maintenance position, defining a maintenance area between the side wall and the hoistway. Maintenance operations on one or more elevator system components are performed from the maintenance area.

Additionally or alternatively, in this or other embodiments maintenance operations are completed at the first selected location and the elevator car is driven to a second selected location. Maintenance operations are performed at the second selected location.

Additionally or alternatively, in this or other embodiments the side wall is returned to the operational position before driving the elevator car to the second selected location.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic of an exemplary elevator system having a 1:1 roping arrangement;

FIG. 1B is a schematic of another exemplary elevator system having a different roping arrangement;

FIG. 1C is a schematic of another exemplary elevator system having a another roping arrangement;

FIG. 2 is a schematic view of an embodiment of an elevator car;

FIG. 3 is another schematic view of an embodiment of an elevator car; and

FIG. 4 is a schematic view of operation of an elevator car wall for access to a hoistway.

### DETAILED DESCRIPTION

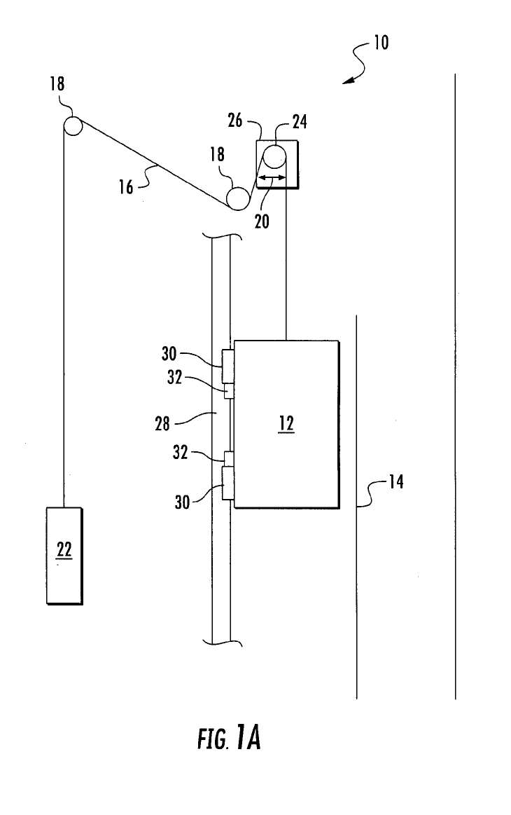

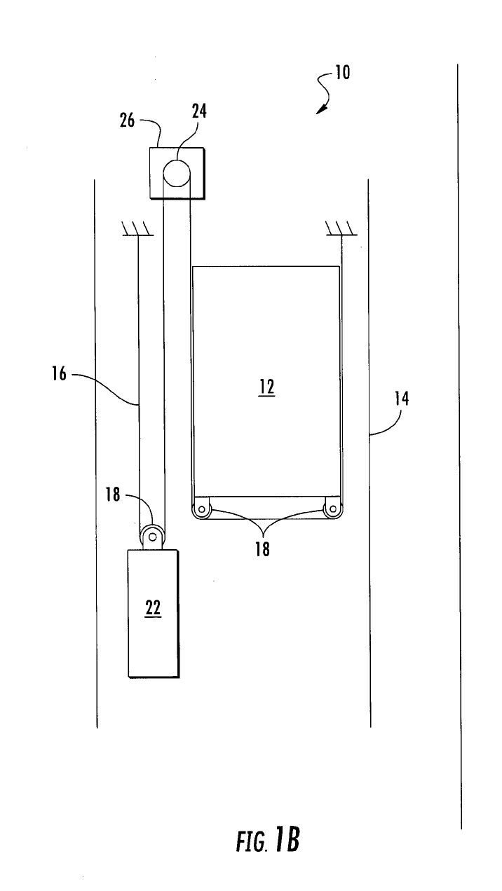

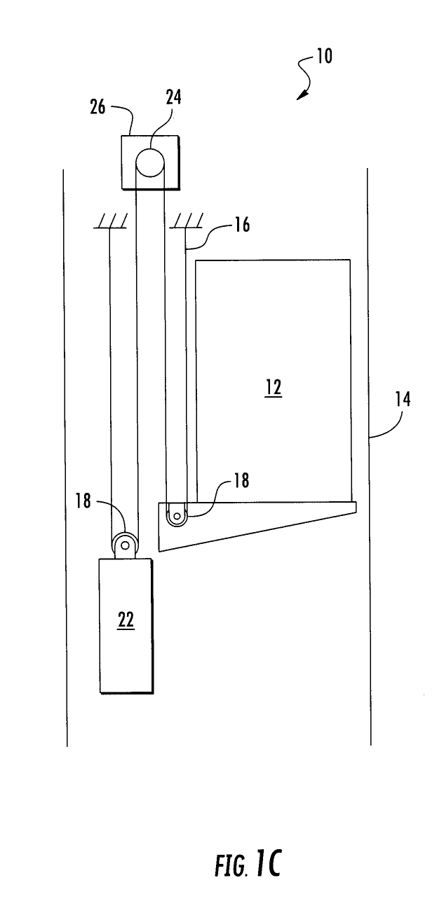

Shown in FIGS. 1A, 1B and 1C are schematics of exemplary traction elevator systems 10. The elevator system 10 includes an elevator car 12 operatively suspended or supported in a hoistway 14 with one or more suspension members 16, such as ropes or belts. The one or more suspension members 16 interact with one or more sheaves 18 to be routed around various components of the elevator system 10. The one or more sheaves 18 could also be connected to a counterweight 22, which is used to help balance the elevator system 10 and reduce the difference in suspension member 16 tension on both sides of a traction sheave 24 during operation.

The sheaves 18 each have a diameter 20, which may be the same or different than the diameters of the other sheaves 18 in the elevator system 10. At least one of the sheaves could be a traction sheave 24. The traction sheave 24 is driven by a machine 26. Movement of traction sheave 24 by the machine 26 drives, moves and/or propels (through traction) the one or more suspension members 16 that are routed around the traction sheave 24.

At least one of the sheaves 18 could be a diverter, deflector or idler sheave. Diverter, deflector or idler sheaves are not driven by the machine 26, but help guide the one or more suspension members 16 around the various components of the elevator system 10. While the embodiments are described in relation to elevator systems with suspension members, one skilled in the art will readily appreciate that the present disclosure may be applied to other types of elevator systems, such as those with self-propelled elevator cars lacking suspension members.

Referring again to FIG. 1A, the elevator system 10 further includes one or more guide rails 28 to guide the elevator car 12 along the hoistway 14. The elevator car includes one or more guide shoes 30 interactive with the guide rails 28 to guide the elevator car 12, and also may include safeties 32 interactive with the guide rail 28 to slow and/or stop motion of the elevator car 12 under certain conditions, such as an overspeed condition.

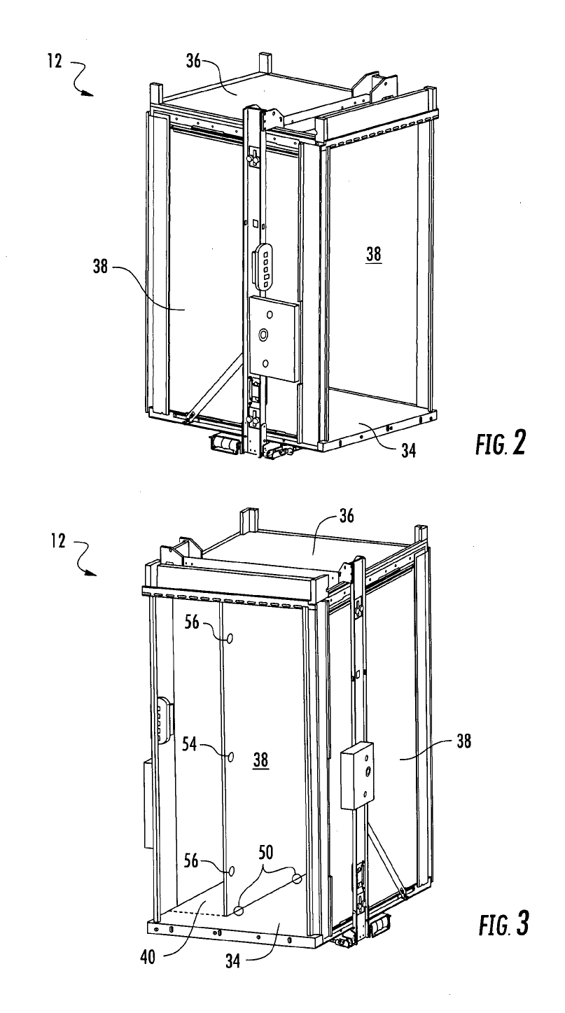

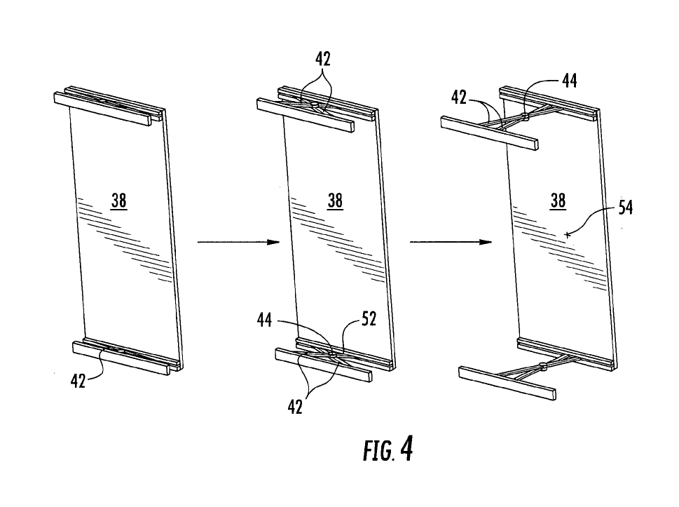

Referring now to FIG. 2, the elevator car 12 includes a floor 34, a ceiling 36 and side walls 38. The elevator car 12 further includes elevator doors (not shown for clarity) to allow ingress and egress of passengers at designated landing floors of the elevator system 10. One or more of the side walls 38 are movable from an operational position, as shown in FIG. 2, to a maintenance position, as shown in FIG. 3. With the side wall 38 in the maintenance position, a technician has access to a maintenance area 40 of the elevator car 12, defined as between the side wall 38 and an interior of the hoistway 14. Access to the maintenance area 40 allows the technician to perform inspection and/or maintenance of components in the hoistway 14, such as a drive cabinet, electrical cabinet, lighting cabinet, machine, car and counterweight buffer, tension device, governor, safeties 32, guide rails 28, suspension members 16 or other elevator system components. The maintenance is performed from the elevator car 12, without the technician having to enter the hoistway 14 either, for example, above the elevator car 12 or below the elevator car 12.

When moving from the operational position to the maintenance position, the side wall 38 translates linearly across the floor 34. In some embodiments, when in the maintenance position, the side wall 38 abuts opposite side wall 38. Linear translation, and linear movement of the entire side wall 38 as a single unit, allows for the movement of the side wall 38 without need to consider space for handrails or other components in the interior of the elevator car 12, as would be necessary with hinged or rotational movement of the side wall. Further, an interior design of the elevator car 12 with, for example, full panel mirrors, handrails, kickplates, etc., does not need to be modified to accommodate a movable side wall 38 of the present disclosure. In the embodiment of FIGS. 2 and 3, the entire side wall 38 translates, but it is to be appreciated that in other embodiments the side wall 38 may be segmented such that, for example, half of the side wall 38 is movable while the remaining portion is stationary, or two portions of side wall 38 are independently movable.

Referring now to FIG. 4, in some embodiments, the motion of the side wall 38 is controlled by a scissor arm arrangement. The arrangement includes a pair of scissor arms 42 located at the floor 34, and in some embodiments, also at the ceiling 36. Each pair of scissor arms 42 is connected at a pivot 44, and slidably connected to the side wall 38 and a fixed portion of a car frame 46. As the side wall 38 is moved from the operational position to the maintenance position by, for example, a pulling or pushing force applied by the technician, the scissor arms 42 rotate about the pivot 44 moving arms ends closer together to guide the motion of the side wall 38 in a linear path Likewise, when the side wall 38 is moved from the maintenance position to the operational position, the scissor arms 42 are rotated about the pivot 44 in an opposite direction to again guide linear motion of the side wall 38.

Referring again to FIG. 3, one or more rollers 50 are positioned at the side wall 38 between the side wall 38 and floor 34 to support the side wall 38 during translation across the floor 34 and ease movement of the side wall 38. To additionally ease movement of the side wall 38 to the maintenance position, a biasing member, for example, a spring 52 (shown in FIG. 4) is provided to bias the side wall toward the maintenance position, such that when unlocked, the side wall 38 is urged toward the maintenance position by the spring 52. The side wall 38 includes a lock 54, for example, an electromagnetic lock that may only be deactivated by a technician, to ensure passenger safety during operation of the elevator system 10. Additionally, a contact 56, latch, or other device may be utilized to retain the side wall 38 in the operational position or the maintenance position.

In operation, the elevator system 10 is switched from normal, passenger conveying, operation to a maintenance mode via, for example, a key switch in the elevator car 12 or a maintenance access combination with car operating panel buttons, located at, for example, a control panel of the elevator car 12. The elevator car 12 is then driven to a selected location in the hoistway 14. The lock 54 is then deactivated and the side wall 38 is moved from the operational position to the maintenance position across the floor, defining the maintenance area 40. The technician enters the maintenance area 40 to perform the intended inspection and/or maintenance operations. Once completed, the side wall 38 can be returned to the operational position 38 and the elevator car 12 is driven to the next selected location for inspection and/or maintenance. Alternatively, the side wall 38 may be kept in the maintenance position when the elevator car 12 is moved along the hoistway 14.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator car for an elevator system comprising:
a floor; and
one or more elevator car side walls;
wherein at least one elevator car side wall is configured to be linearly translatable at least partially across the floor from an operational position to a maintenance position to allow for inspection and/or maintenance of elevator system components from inside of the elevator car when the elevator car side wall is at the maintenance position.

2. The elevator car of claim 1, further comprising a scissor arm arrangement to operably connect the movable elevator car side wall to a stationary elevator car structure, to guide the linear translation of the elevator car side wall across the floor.

3. The elevator car of claim 1, further comprising a roller affixed to the elevator car side wall and interactive with the floor to support the elevator car side wall during translation across the floor.

4. The elevator car of claim 1, further comprising a biasing member to bias the elevator car side wall toward the maintenance position.

5. The elevator car of claim 1, further comprising a lock to retain the elevator car side wall at the operational position.

6. An elevator system comprising:
a hoistway;
one or more elevator system components located in the hoistway;
an elevator car drivable along the hoistway, the elevator car including:
a floor; and
one or more elevator car side walls;
wherein at least one elevator car side wall is configured to be linearly translatable at least partially across the floor from an operational position to a maintenance position to allow for inspection and/or maintenance of the elevator system components located in the hoistway from inside of the elevator car when the elevator car side wall is at the maintenance position.

7. The system of claim 6, further comprising a scissor arm arrangement to operably connect the movable elevator car side wall to a stationary elevator car structure, to guide the linear translation of the elevator car side wall across the floor.

8. The elevator system of claim 6, further comprising a roller affixed to the elevator car side wall and interactive with the floor to support the elevator car side wall during translation across the floor.

9. The elevator system of claim 6, further comprising a biasing member to bias the elevator car side wall toward the maintenance position.

10. The elevator system of claim 6, further comprising a lock to retain the elevator car side wall at the operational position.

11. A method of operating an elevator system comprising:
driving an elevator car along a hoistway;
stopping the elevator car at a first selected location along the hoistway;
linearly translating a side wall of the elevator car at least partially across a floor of the elevator car from an operational position to a maintenance position, defining a maintenance area between the side wall and the hoistway; and
performing maintenance operations on one or more elevator system components from the maintenance area.

12. The method of claim 11, further comprising:
completing maintenance operations at the first selected location;
driving the elevator car to a second selected location; and
performing maintenance operations at the second selected location.

13. The method of claim 12, further comprising returning the side wall to the operational position before driving the elevator car to the second selected location.
